(19) United States
(12) Patent Application Publication
(10) Pub. No.: US 2008/0146286 A1
(43) Pub. Date: Jun. 19, 2008

(54) MOBILE TERMINAL PROVIDING MULTIPLE VIEW DISPLAY AND MULTIPLE VIEW DISPLAY METHOD

(75) Inventors: Young-Soo BYUN, Gwangju-si (KR); Bum-Taek LIM, Yongin-si (KR); Han-Bit CHUNG, Gwangmyeong-si (KR); Min-Ju YOO, Seongnam-si (KR)

Correspondence Address: Jefferson IP Law, LLP, 1730 M Street, NW, Suite 807, Washington, DC, 20036, US

(73) Assignee: Samsung Electronics Co., Ltd, Suwon-city (KR)

(21) Appl. No.: 11/738,963

(22) Filed: Apr. 23, 2007

(30) Foreign Application Priority Data
Dec. 19, 2006 (KR) 2006-130098

(51) Int. Cl. H04B 1/38

(52) U.S. Cl. 455/566

(57) ABSTRACT

A mobile terminal for providing multiple views and a multiple view display method are disclosed. The mobile terminal controls a display region so as to display at least one view for a currently executed applet, and changes display parameters included in a corresponding view according to a size of the controlled display region. Further, when more than one view is displayed, a focus may be set on any one of the displayed views according to a user's selection. When a user's key input occurs, the key input can be recognized as an input of a view having a currently set focus. Accordingly, because the user may easily identify a destination directory, a source directory, and files through a plurality of views according to an execution order, the user can more easily manage files stored in the mobile terminal.

### PRIORITY

This application claims the benefit under 35 U.S.C. § 119(a) of a Korean patent application filed in the Korean Industrial Property Office on Dec. 19, 2006 and assigned Serial No. 2006-130098, the entire disclosure of which is hereby incorporated by reference.

### BACKGROUND OF THE INVENTION

1. Field of the Invention

The present invention relates to a mobile terminal. More particularly, the present invention relates to a device and method for managing files in a mobile terminal.

2. Description of the Related Art

In general, when a user employs a mobile terminal to manage files, the mobile terminal displays one view at a time. A view may include, for example, a user interface (UI) display screen used to either display a list of files or directories or detailed information thereof, or to drive a specific function of the terminal such as a reproduction of music files.

As an example, FIGS. 1A to 1D illustrate different views that may be displayed on a mobile terminal. More specifically, FIGS. 1A to 1D are views illustrating examples of screens that are displayed when a user stores a received message in a designated storage box of the mobile terminal.

With reference to FIG. 1A, when the user selects a storage box for the received message, the mobile terminal displays an indicator bar 100, a menu bar 106, a title bar 102, and a view 104. The indicator bar 100 may include indicator icons for displaying remaining battery capacity and a current status or strength of a received signal. The menu bar 106 may include soft keys such as a menu key, a confirm key, or a cancel key which the user can select. The view 104 displays a UI for a received message storage box applet which the user has currently selected.

In this case, when the user selects the ‘menu key’, the mobile terminal displays a menu screen 108 that includes menu items corresponding to the input ‘menu’ soft key, as illustrated in FIG. 1B. Further, in this state, when the user selects a menu item from those corresponding to the ‘menu’ soft key as illustrated in FIG. 1B, a menu screen 110, capable of selecting any one of plural storage boxes, is displayed as illustrated in FIG. 1C. Moreover, when the user selects a special storage box, for example when the user selects from among the storage boxes displayed in FIG. 1C, a view 112 is displayed in order to show messages currently stored in the corresponding storage box, as illustrated in FIG. 1D.

As described above with reference to FIGS. 1A to 1D, in the case of a general mobile terminal only one view is displayed after each selection by the user. Other views can not be simultaneously displayed. For example, as illustrated in FIG. 1B and FIG. 1C, when the user inputs the ‘menu key’ and selects any one menu item therefrom, as illustrated in FIG. 1D, only one view 112 can be displayed according to an applet execution result.

Therefore, in the case of the general mobile terminal, for file management and the like, the user is only able to view results of changes made by the user as part of the current manipulation. For example, as illustrated in FIGS. 1A to 1D, when the user moves a specific stored file, the user is only able to view a directory (source directory) in which corresponding files are stored prior to the file being moved by the user. After the movement of the file, the user is only able to view a directory (destination directory) to which the corresponding file is moved. Although a list of directories is displayed, it is difficult to identify which directory stores a file. Therefore, because the user cannot view the different directories and thus cannot easily identify a transfer or a position of selected files in the general portable mobile communication device, it is difficult to manage files.

### SUMMARY OF THE INVENTION

Accordingly, the present invention has been made to address the above-mentioned problems and an aspect of the present invention is to provide a device and method for easily managing stored files and displaying multiple views on a mobile terminal.

Also, an aspect of the present invention is to provide a device and method for easily managing files and controlling an applet being executed by a user of a mobile terminal by providing a plurality of views for the applet being executed.

In accordance with an aspect of the present invention, a mobile terminal for providing a multiple view display is provided. The terminal includes a display device comprising a display screen for displaying at least one view thereon, a memory unit for storing information relating to the number of views to be generated and for storing view size information corresponding to the number of views, and a controller for determining a specific number of views to be generated according to the number of views being currently displayed and a generation of a new view, for changing at least one view being currently displayed according to view size information corresponding to the determined specific number of views, for generating the new view according to the view size information, and for dividing a display region of the display screen and controlling the display device so that the view having the changed size and the newly generated view are displayed on the display screen.

In accordance with another aspect of the present invention, a method for displaying a multiple view in a mobile terminal is provided. The method includes changing a size of at least one view being currently displayed according to the number of the views when the generation of a new view is selected, generating the new view and displaying the newly generated view and the at least one view having the changed size on one screen of a display device of the mobile terminal by dividing a display region of the display device.

### BRIEF DESCRIPTION OF THE DRAWINGS

The above and other aspects, features and advantages of the present invention will be more apparent from the following detailed description of certain exemplary embodiments taken in conjunction with the accompanying drawings, in which:

FIGS. 1A to 1D are views illustrating examples of screens displayed on a conventional mobile terminal;

FIG. 2 is a block diagram illustrating a construction of a mobile terminal according to an exemplary embodiment of the present invention;

FIG. 3 is a flowchart illustrating a multiple view display operation according to an exemplary embodiment of the present invention;

FIGS. 4A to 4C are views illustrating examples of a multiple view generation screen according to an exemplary embodiment of the present invention;

FIG. 5 is a detailed flowchart illustrating an operation for generating a size of a view region during the multiple view display operation according to an exemplary embodiment of the present invention;

FIG. 6 is a detailed flowchart illustrating an operation for generating a new view during the multiple view generation screen operation according to an exemplary embodiment of the present invention; and

FIG. 7 is a detailed flowchart illustrating a procedure for changing a display position of views according to a generation of the new view during the multiple view display operation according to an exemplary embodiment of the present invention.

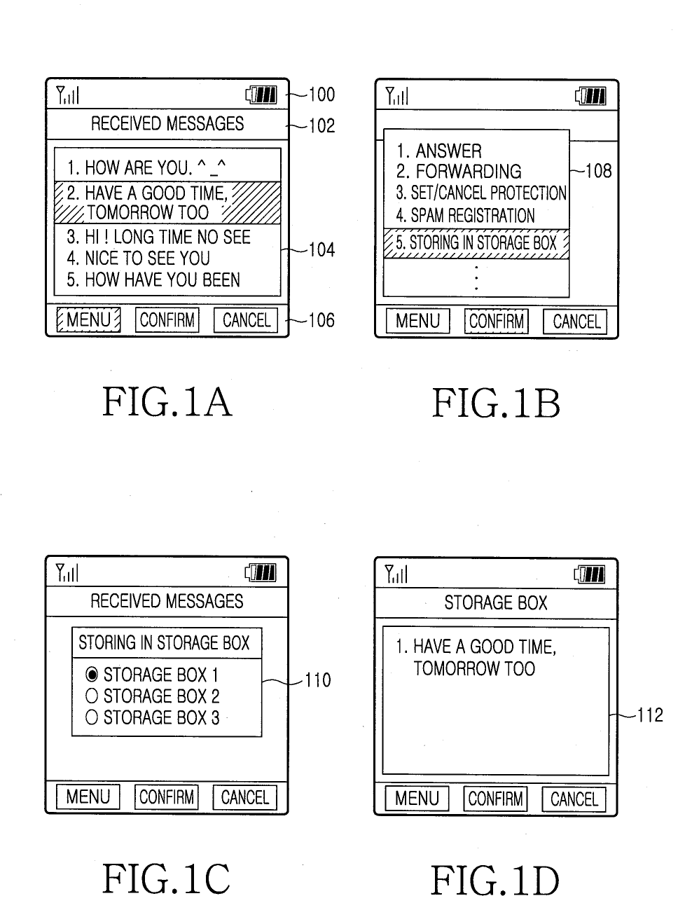

Throughout the drawings, like reference numerals will be understood to refer to like parts, components and structures.

### DETAILED DESCRIPTION OF EXEMPLARY EMBODIMENTS

The following description is provided to assist in a comprehensive understanding of the invention as defined by the claims and their equivalents. It includes various specific details to assist in that understanding but these are to be regarded as merely exemplary. Accordingly, those of ordinary skill in the art will recognize that various changes and modifications of the embodiments described herein can be made without departing from the scope and spirit of the invention. For example, various elements found in the following description, such as specific values of packet identifications, contents of displayed information and the like are provided only to help with a general understanding of the present invention, and it should be apparent to those skilled in the art that the present invention may be implemented without the specifics of these elements. Furthermore, in the following description, detailed descriptions of known functions and configurations are omitted for clarity and conciseness.

To aid in an understanding of the present invention, a basic principle thereof will first be explained. Exemplary embodiments of the present invention provide a device and method for controlling a display region (size) of a view so that a mobile terminal may concurrently display two or more views for a currently executed applet. Also, exemplary embodiments of the present invention provide a device and method for changing a set of display parameters corresponding to a view according to a size of the controlled display region or size of the view. Furthermore, exemplary embodiments of the present invention provide a device and method that enable a user to set a focus on any one of the displayed views when two or more views are displayed. For instance, when a user's input is received, for example through a key input, the key input can be recognized as an input corresponding to a view on which the focus is currently set. Accordingly, embodiments of the present invention allow a user to more easily determine file management parameters, for example more easily identify a destination directory, a source directory, and file identities through a plurality of views according to an execution order, and therefore allow the user to more easily manage files in the mobile terminal.

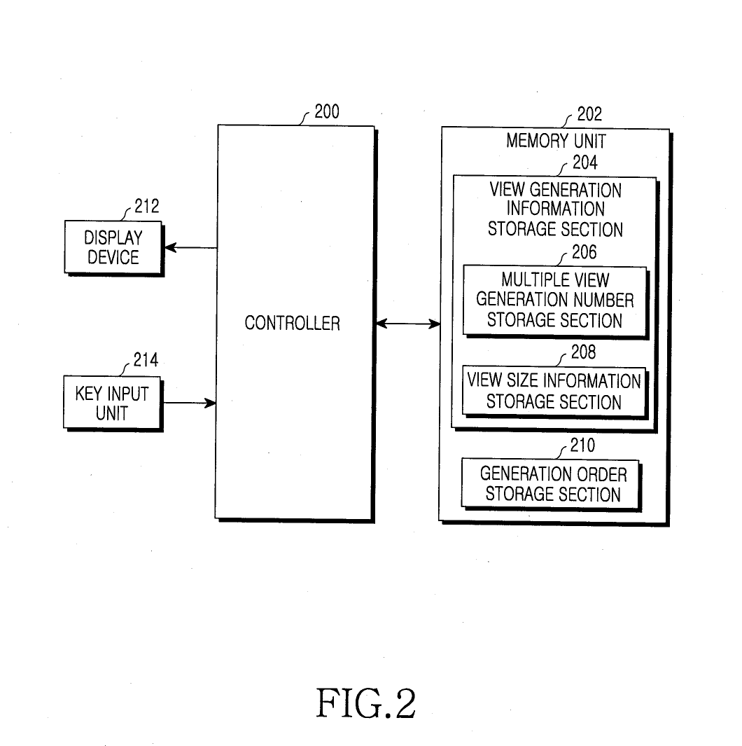

FIG. 2 is a block diagram illustrating a construction of a mobile terminal according to an exemplary embodiment of the present invention.

With reference to FIG. 2, a mobile terminal according to an exemplary embodiment of the present invention may include a controller 200, a memory unit 202, a key input unit 214, and a display device 212. The memory unit 202, the key input unit 214, and the display device 212 are connected to the controller 200 either electrically, physically or both. The controller 200 may exchange a voice signal and/or data signal according to a set protocol such as a telephone call, a data communication, or a wireless Internet connection. Further, the controller 200 may process data according to the set protocol and may control each part of the mobile terminal. Moreover, the controller 200 may receive a user's input, for example through the key input unit 214, and may control the display device 212 according to the user's input so that image information according to the user's input is generated and a corresponding image is provided to the user.

In addition, when an applet, other than an applet that the user is currently executing, is selected according to a user's input, the controller 200 is able to change a size of a view of the currently executed applet according to view size information corresponding to the number of views to be displayed. Also, the controller 200 is able to change a size of the view of the currently executed applet according to a number of generated views as set by the user. The controller 200 is also able to change a set of display parameters included in a corresponding view region according to the number of views to be displayed. Furthermore, the controller 200 may display information of the applet corresponding to each view according to the changed set of display parameters. Thus, in a mobile terminal according to an exemplary embodiment of the present invention, a display region of the display device 212 is divided into sub-regions, and a view having a changed size and a newly generated view are each displayed in a sub-region as one screen.

In an exemplary embodiment, the set of display parameters may be a font size of the data included in a corresponding view. For example, where a font size before a size of a display region is changed is 11 point, when the size of the display region is changed, the controller 200 may change the font size according to the number of currently set multiple views to 7 point. Accordingly, when the size of the display region is changed, all of the characters, numbers, signs and other data displayed on a corresponding display region can have a size other than the size prior to a change thereof. While the font size of data in a corresponding view has been used as an exemplary set of display parameters, the set of display parameters is not limited thereto and may include other parameters.

The controller 200 may change the size of the display region and the set of display parameters differently according to a current state of the mobile terminal. For example, when a mobile terminal according to an exemplary embodiment of the present invention has a rotatable display device 212, the controller 200 may control a size of the display region and a set of display parameters differently according to the rotational position of the display device 212. In an exemplary embodiment, the memory unit 202 may store different sizes of the display region and different sets of display parameters according to a state of the display device 212.

When a plurality of views are displayed, the controller 200 may set a focus on one of the views according to a user's selection. In exemplary embodiments, setting of the focus may be achieved using a specific key physically included in the key input unit 214 or a soft key generated during a display of a multiple view. Further, when the key input unit 214 includes a touch screen, the focus may be set according to an input of the touch screen.

When a focus is set on a specific view, the controller 200 recognizes input, for example key input, as input for the applet corresponding to the view on which the focus is currently set. For example, when a first view which includes a list of music files and a second view which includes a UI for playback of music files are both displayed in a multiple view state, the user may set a focus on the first view in which the list of the music files is displayed. With focus set on the first view which includes a list of music files, the user may input a movable key so that the input of the movable key is used to select specific music files. However, if the same key is used when the user sets the focus on the second view which includes the UI for controlling playback of musical files, the key input can be recognized by the controller 200 as a key input for controlling musical file playback such as a speed adjustment, stop, or reproduction of music data. Of course, the specifics of these views and controls are merely exemplary and the invention is not limited thereto.

In another exemplary embodiment in a state in which a plurality of views are displayed, the controller 200 may compare the number of currently displayed views with a set number of views and may change a display position of generated views according to the comparison result. In an exemplary embodiment, the set number may be previously established by a user. When the number of currently executed views is less than the set number of views, the controller 200 may change display regions and sets of display parameters of currently displayed views, and generate and display a new view. However, when the number of currently executed views is identical to the set number of views, the controller 200 may stop displaying a currently displayed view. In an exemplary embodiment, the controller 200 may stop displaying the earliest generated view. Further, the controller 200 may display a newly generated view next to the view on which the display stops and may display a current view that is not stopped on the display region of the view in which the display currently stops. In this manner, display positions of the currently displayed views and the newly generated view are changed according to a generation order and they are displayed. Alternatively, the newly generated view may be displayed in the display region of the view which is currently stopped.

The memory unit 202 connected to the controller 200 may include a read only memory (ROM), a flash memory, and/or a random access memory (RAM). The memory unit 202 may store programs and reference data for processing and controlling the controller 200. Further, the memory unit 202 may provide a working memory for the controller 200 and an area for storing data. The memory unit 202 can be upgraded.

The memory unit 202 may include a view generation information storage section 204 and a generation order storage section 210. The view generation information storage section 204 may store information for generating a multiple view. The generation order storage section 210 may store a generation order of views, which are currently displayed on the display device 212. The view generation information storage section 204 may store the number of views to be generated and a set of display parameters corresponding to the number of the views. In an exemplary embodiment, the set of display parameters may be size information of a specific font. Further, the number of views and size information of the views according to a current state of the display device 212 are stored corresponding to the number of the views. Hereinafter, an area for storing the number of views to be generated and the set of display parameters corresponding to the number of views to be generated is referred to as ‘multiple view generation number storage section’ 206. An area for storing the size information of the views and the number of views is referred to as ‘view size information storage section’ 208.

As described earlier, the key input unit 214 includes different kinds of keys, including number keys. The key input unit 214 may be employed by a user to provide input to the controller 200. As mentioned above, the key input unit 214 may include a key for setting a focus on any one view included in the multiple views. Further, the key input unit 214 may be used to supply an input from any one of the keys to the controller 200 as a key input for moving the focus. In addition, the key input unit 214 may include the aforementioned touch screen as a means for key input.

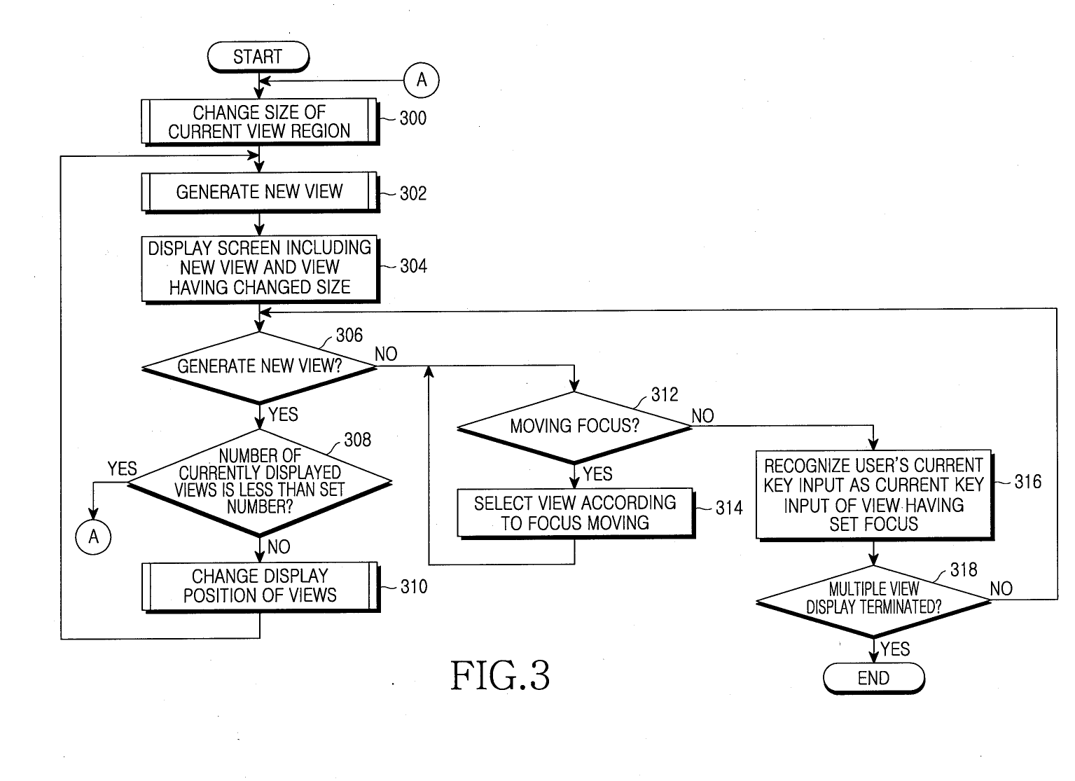

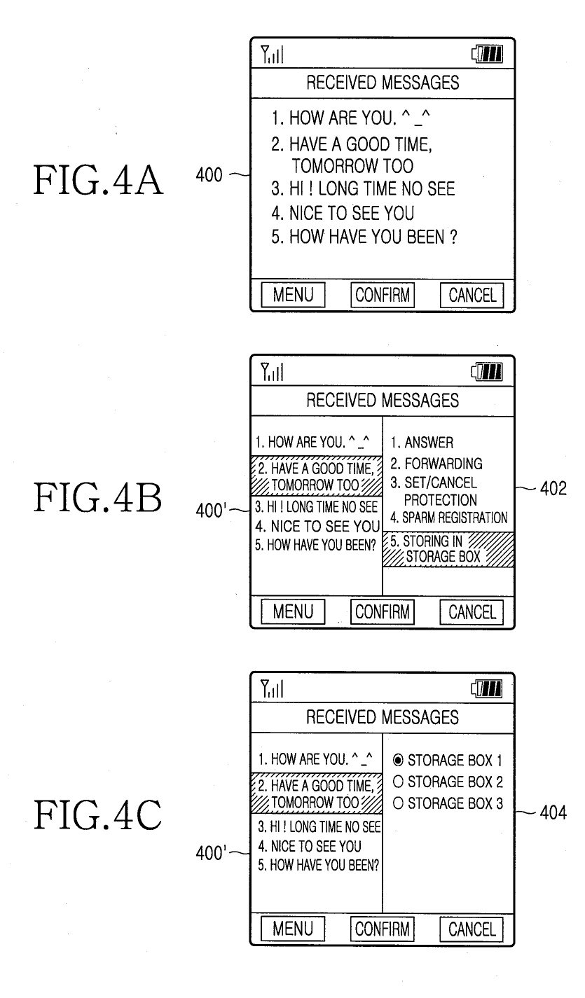

FIG. 3 is a flowchart illustrating a multiple view display operation according to an exemplary embodiment of the present invention. FIGS. 4A to 4C are views illustrating examples of a multiple view generation screen according to an exemplary embodiment of the present invention.

With reference to FIG. 3, when a user's selection for generating a multiple view occurs, the controller 200 of a mobile terminal according to an exemplary embodiment of the present invention determines whether or not an applet, other than an applet being currently executed, is to be executed. When another applet is to be executed, the routine proceeds to step 300 and the controller 200 changes a current size of a display region according to the number of views being currently displayed or the number of views to be generated according to the user's selection. Further, the controller 200 changes a set of display parameters corresponding to a currently changed view region according to the changed size of the view. In step 302, the controller 200 generates a view for the newly executed applet. In step 304, the controller 200 displays a screen including a current view having a changed size and a newly generated view.

FIGS. 4A to 4C are views illustrating an example of generated multiple views. The present example provides multiple views in which the number of views is two views. However, it is to be understood that this is merely exemplary and the present invention is not so limited. For example, the present invention contemplates embodiments in which the number of multiple views is greater than two.

FIG. 4A illustrates a state in which multiple views are selected. In an exemplary embodiment as illustrated in FIG. 4A, an applet is being executed that displays a list of received messages 400. From this state, a user may input a ‘menu’ key so as to display a menu options screen 402 as illustrated in FIG. 4B. Upon this input selection, the controller 200 changes a size of the view on which the list of the messages was displayed (400) according to the currently set number of multiple views (for example, two), and changes a set of display parameters displayed on a corresponding view according to the currently set number of multiple views (for example, reduction of a font size). Therefore, as illustrated in FIG. 4B, the controller 200 displays a current view having a changed size 400′ and a newly generated view 402. The controller also displays a main screen.

In a state in which multiple views are selected, the controller 200, in step 306, determines whether or not a user selects a generation of a new view. Here, the controller 200 can determine that the user selects the generation of a new view when an applet, other than an applet being currently executed is to be executed. For example, when an applet for displaying a list of storage boxes is executed, as illustrated in FIG. 4C, a view 404 according to the corresponding newly executed applet is displayed.

As illustrated in FIG. 4C, when a user again selects the generation of a new view in a state in which multiple views are currently being displayed, the controller 200 determines in step 308 whether or not the number of views being currently displayed is less than the set number of views. As a result of the determination in step 308, when the number of views being currently displayed is less than the set number of views, in step 300 the controller 200 changes a size of views being currently displayed so as to generate a new view according to the set number of generated views. As discussed above, the set number of views may have been previously selected by a user.

For example, if a single view is currently being displayed and the set number of multiple views is three, when a user first selects a multiple view display, a new view is generated. That is, the controller 200 changes the number of currently displayed views, namely by changing a size of the currently displayed view and generating a new view. Accordingly, in an exemplary embodiment of the present invention, two views are now displayed.

When the user again selects the generation of a new view, for example when a new applet is again executed, the controller 200 compares the number of currently displayed views, namely 2, with the set number, namely 3 in step 308. Accordingly, since the number of the currently displayed views is less than the set number, the controller 200 returns to step 300 and changes a size of the currently displayed views in order to again generate a new view in step 302.

The controller 200 displays a screen including a newly generated view and views having a changed size in step 304. The routine proceeds to step 306 and the controller 200 determines whether or not the user selects a new view.

On the other hand, as a result of the determination in step 308, when the number of currently displayed views is not less than the set number of views, the controller 200 proceeds to step 310 and changes a display position of the currently displayed views. That is, the controller 200 stops a display of a currently displayed view and upgrades a generation order of the remaining views according to the stopping of one of the displayed views. In an exemplary embodiment, the display that is stopped is the earliest displayed view. Further, according to the upgraded generation order, respective views may be displayed at a display position according to each generation order.

In an exemplary embodiment, when the set number of views is two, as in a state illustrated in FIG. 4C, when a user executes a new applet, the controller 200 determines the number of currently displayed views and compares the determined number of the currently displayed views with the set number of multiple views in step 308. As a result of the comparison, when the determined number of the currently displayed views is not less than the set number of multiple views, the controller 200 stops the view 400′ (having, for example, a generation order of number 1), which was displayed first of all. As the display of the view 400′ stops, a generation order of the remaining view 404 is upgraded. Accordingly, in this example, a generation order of the view 404 is upgraded from number 2 to number 1. As a display of existing view 400′ stops, the remaining view 404 becomes the earliest generated view, and the view 404 may be displayed at the position where the view 400′ was displayed in step 310. The controller 200 returns to step 302 and generates a new view by a user's selection. When the new view is generated, the controller 200 sets a generation order of the new view (for example, the generation order of the new view is number 2). Accordingly, the new view is again displayed at the position where the existing view 404 had been displayed.

On the other hand, when the user does not select the generation of the new view in step 306, the controller 200 proceeds to step 312 and determines whether or not the user changes a focus from a current view having the set focus to another view. As a result of the determination in step 312, when the user selects a changing of the focus, the controller 200 proceeds to step 314 and selects a view according to the movement of the focus. In an exemplary embodiment, the changing of the focus can be sensed by an input of a focus moving key through the key input unit 214.

On the other hand, when the user does not change the focus in step 312, the controller 200 proceeds to step 316 and recognizes a user's current input, for example key input, as an input for the view having the currently set focus. Moreover, the controller 200 controls an operation of an applet corresponding to the view having the currently set focus according to a user's input. The controller 200 proceeds to step 318 and determines whether or not the user selects a termination of the multiple views display. When the user does not select a termination of the multiple views, the controller 200 returns to step 306 and determines whether or not the user selects a generation of a new view. The procedure from step 306 to step 318 repeats. However, when the user terminates the multiple views display in step 318, the controller 200 terminates the multiple views display, selects a view having a currently set focus and changes a size and a display set of the selected view according to a typical single view display manner. Further, the controller 200 displays one changed view according to a single view display manner.

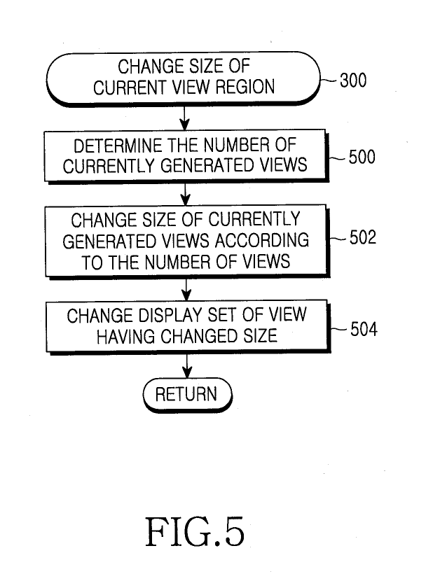

FIG. 5 is a detailed flowchart illustrating an operation for generating a size of a view region during the multiple view display operation according to an exemplary embodiment of the present invention.

Referring to FIG. 5, when multiple views are selected by a user and a new applet is executed according to the user's selection, the controller 200, according to an exemplary embodiment of the present invention, proceeds to step 500 and determines the number of views to be generated.

The controller 200 proceeds to step 502 and changes a size of a currently generated view according to the number of views to be generated. Here, at least one view region having a changed size may be provided. For example, when a multiple view is initially generated, one view having a changed size can be provided. However, when multiple views are currently displayed and, as a result of the comparison in step 308 the number of currently displayed views is determined to be less than the number of views set by the user, the number of views having a changed size can be two or more. The controller 200 determines view size information corresponding to a value obtained by increasing the number of currently generated views by 1 from a view size information storage section 208 and changes a size of a view according to the read value.

The controller 200 proceeds to step 504 and reads a set of display parameters according to the number of currently generated views from the view generation information storage section 204, and changes a set of display parameters of the view having the changed size according to the read set of display parameters.

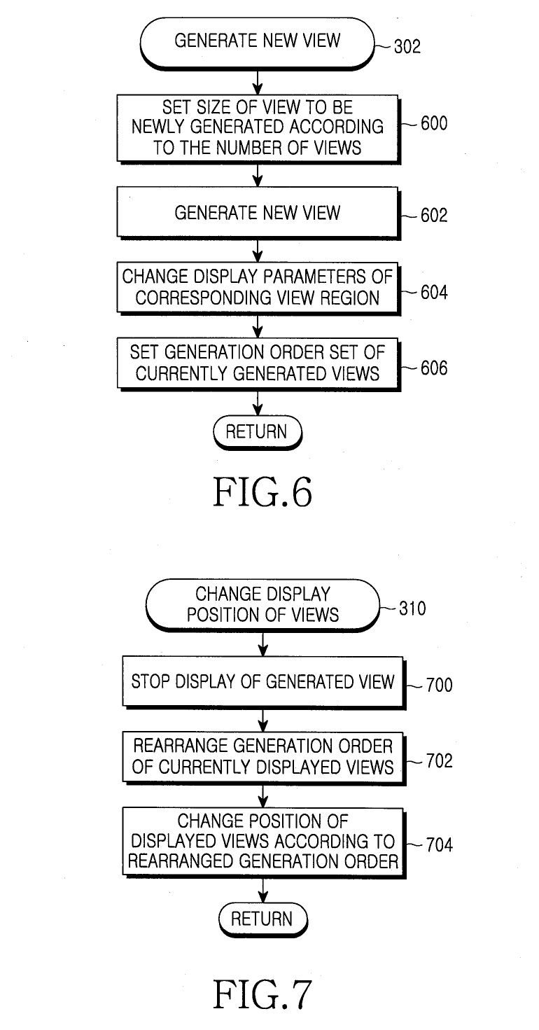

FIG. 6 is a detailed flowchart illustrating an operation for generating a new view during a multiple view display operation according to an exemplary embodiment of the present invention.

With reference to FIG. 6, when a view being currently displayed is terminated or the number of currently generated views is less than the set number of multiple views, the controller 200 sets a size of a view to be newly generated according to the number of views to be generated. For example, the controller 200 determines view size information corresponding to a value obtained by increasing the number of currently generated views by 1 from the view size information storage section 208, and sets a size of a view to be newly generated according to the determined view size information in step 600. Further, the controller 200 proceeds to step 602 and generates a new view according to the set size of the view.

Furthermore, the controller 200 proceeds to step 604 and determines display set parameters corresponding to the number of views to be generated, including the newly generated view, from the multiple view generation number storage section 206. The controller 200 uses the determined set of display parameters for a view region to be newly generated. Next, the controller 200 proceeds to step 606 and sets a generation order for currently displayed views. That is, in step 606, the controller 200 sets the generation order of the views after the currently generated view is finally generated. In an exemplary embodiment, when the user selects multiple views and a new view is generated, the present invention changes a size of currently displayed views and a set of display parameters implemented in a corresponding view so as to continuously generate and display new views according to the number of generated views and the set number of views, for example as set by the user.

However, as described earlier, when the number of currently displayed views is not less than the set number of multiple views, after the controller 200 stops a display of any one among the currently displayed views and changes a display position, it generates and displays a new view. FIG. 7 is a detailed flowchart illustrating a procedure for changing a display position of views according to a generation of the new view during the multiple view display operation according to an exemplary embodiment of the present invention.

Referring to FIG. 7, when the number of currently displayed views is determined not to be less than the set number of multiple views in step 308 of FIG. 3, the controller 200 proceeds to step 700 to stop a previously generated view. In an exemplary embodiment, the controller 200 in step 700, stops the earliest generated view (for example, stops the view having a generation order of number 1). The controller 200 proceeds to step 702 and rearranges the generation order of the currently displayed views according to a previously generated order. For example, the generation order of currently remaining views is increased one by one.

The controller 200 proceeds to step 704 and changes a position of the currently displayed views according to the rearranged generation order. For example, a view corresponding to a current generation order of number 1 is moved and displayed in a display position corresponding to the generation order of number 1. As a further example, because the generation order of currently displayed views is rearranged in step 702, the view previously displayed at a view display position of a generation order of number 2 may be displayed at a view display position of a generation order of number 1 in step 704. Further, if there are remaining views, a display position thereof is changed in the same manner.

Accordingly, exemplary embodiments of the present invention provide a plurality of views for an applet that a user has executed so that the user may more easily manage files and more easily control an applet, which is currently executed.

An exemplary embodiment of the present invention has been described wherein the number of multiple views is two. However, the number of multiple views is not limited thereto. Further, in FIGS. 4A to 4C, it was illustrated that multiple views of the present invention are obtained by equally dividing a transverse length of a display screen according to the set number of multiple views. However, other configurations are also possible. For example, a longitudinal length of a display screen can be equally divided according to the set number of multiple views.

Moreover, in FIGS. 4A to 4C, views of an applet on which a file list and a directory list are displayed were illustrated as an example. However, the view and application of the present invention is not limited thereto. Namely, for example, the present invention is applicable to a case of an applet for displaying detailed information of a specific file or directory or a case of an applet for driving specific functions.

While the invention has been illustrated and described with reference to exemplary embodiments thereof, it will be understood by those skilled in the art that various changes in form and details may be made therein without departing from the spirit and scope of the invention as defined by the appended claims and their equivalents.

What is claimed is:

1. A mobile terminal for providing a multiple view display, comprising:
a display device for displaying at least one view;
a memory unit for storing information relating to a number of views to be generated and for storing view size information corresponding to the number of views; and
a controller for determining a specific number of views to be generated according to a number of views being currently displayed and a generation of a new view, for changing at least one view being currently displayed according to view size information corresponding to the specific number of views to be generated, for generating the new view according to the view size information, and for dividing a display region of the display screen and controlling the display device so that the view having the changed size and the newly generated view are displayed.

2. The mobile terminal according to claim 1, further comprising a key input unit, wherein an input of the key input unit is generated as an input for an applet corresponding to a view having a focus which is set from among the displayed views.

3. The mobile terminal according to claim 1, wherein the changing of the at least one view being currently displayed comprises changing at least one of a size and a display position of the at least one view being currently displayed according to whether the number of views being currently generated is less than a set number of views when the new view is generated.

4. The mobile terminal according to claim 3, wherein the controller stops a display of a displayed view according to a generation order when the display position of the at least one view being currently displayed is changed, rearranges the generation order, and changes a display position according to the rearranged generation order.

5. The mobile terminal according to claim 1, wherein the memory unit stores at least one set of display parameters corresponding to each of the number of the views to be generated.

6. The mobile terminal according to claim 5, wherein the controller determines one of the at least one set of display parameters corresponding to the specific number of views to be generated and applies the at least one set of display parameters to the view that is changed.

7. The mobile terminal according to claim 5, wherein the at least one set of display parameters comprises a font size.

8. The mobile terminal according to claim 1, wherein the display device is rotatable.

9. The mobile terminal according to claim 8, wherein the memory unit further stores a size and at least one set of display parameters corresponding to a view according to a rotated state of the display device, and
the controller determines the size and the set of at least one display parameters of the view according to whether the display device is rotated.

10. The mobile terminal according to claim 2, wherein the key input unit comprises a focus moving key for moving a focus between the displayed views.

11. The mobile terminal according to claim 10, wherein an input of the focus moving key is sensed by a key input through at least one of a touch screen, a physical key, and a soft key.

12. A method for displaying a multiple view in a mobile terminal, the method comprising:
changing a size of at least one view being currently displayed according to a number of views to be displayed when a generation of a new view is selected;
generating the new view; and
displaying the newly generated view and the at least one view having the changed size on a display device of the mobile terminal by dividing a display region of the display device.

13. The method according to claim 12, further comprising:
receiving an input as an input for an applet corresponding to a view having a focus which is set from among the displayed views.

14. The method according to claim 13, wherein the receiving of the input comprises:
receiving a first key input for moving the focus;
setting the focus on one of the displayed views according to the receipt of the key input for moving the focus; and
receiving a second key input as an input of an applet corresponding to a view, the focus of which is currently set.

15. The method according to claim 12, wherein the changing of the size of the at least one view comprises:
determining the number of the at least one view being currently displayed;
selecting a number of new views to be generated according to the number of the at least one view being currently displayed;
determining view size information and a set of display parameters corresponding to the selected number of new views to be generated;
changing a size of the at least one view being currently displayed according to the determined view size information; and
changing a set of display parameters of currently displayed views according to the determined set of display parameters.

16. The method according to claim 12, wherein the generating of the new view comprises:
selecting a number of total views to be displayed according to the number of currently displayed views;
setting a size of a view to be newly generated according to view size information corresponding to the selected number of total views to be displayed;
generating a new view region according to the set size of the view; and
changing a set of display parameters corresponding to a view region according to the selected number of total views to be displayed.

17. The method according to claim 12, further comprising:
comparing the number of currently displayed views with a set number of multiple views; and
changing a size of the currently displayed views according to whether the number of currently displayed views is less than the set number of multiple views.

18. The method according to claim 17, wherein the generating of the new view comprises setting a generation order of the generated view.

19. The method according to claim 18, wherein the comparing of the number of currently displayed views comprises:
changing a display position of the at least one currently displayed view when the number of currently displayed views is equal to or greater than the set number of multiple views and displaying the at least one currently displayed view in the changed display position.

20. The method according to claim 19, wherein the changing of the display position comprises:
stopping a display of an earliest displayed view which is determined according to a generation order of the currently displayed views;
determining a new generation order of the currently displayed views; and
changing a display position according to the newly determined generation order of the currently displayed views to display the currently displayed views.

21. A mobile terminal for providing a multiple view display, comprising:
a display device; and
a controller for displaying at least one first view on the display device, for generating a second view corresponding to input from a user, for changing a display size of the at least one first view upon generation of the second view, and for displaying the at least one first view having the changed display size and the second view simultaneously on the display device.

22. The mobile terminal according to claim 21, wherein the changed display size of the at least one first view and a display size of the second view correspond to a total number of views to be displayed.

23. The mobile terminal according to claim 21, wherein the controller changes the display size of the at least one first view according to whether a total number of first views currently displayed is less than a set number when the second view is generated.

24. The mobile terminal according to claim 21, wherein the at least one first view comprises two first views, and the controller terminates the display of one of the two first views according to a generation order of the two first views, changes a display position of the remaining first view, displays the second view in a display position of the terminated view, and updates the generation order of the remaining first view and the second view.

25. The mobile terminal according to claim 21, further comprising a memory unit, wherein the memory unit stores display parameters corresponding to a total number of the views to be displayed and wherein the changed display size of the at least one first view and the display size of the second view correspond to the display parameters.

26. The mobile terminal according to claim 25, wherein the display parameters comprise a font size.

27. The mobile terminal according to claim 21, further comprising a key input unit, wherein the controller sets a focus on one of the at least one first views and the second view by input from the key input unit and further wherein the controller operates on the view having the focus by input through the key input unit.
